(19) United States
(12) Patent Application Publication
(10) Pub. No.: US 2008/0027820 A1
(43) Pub. Date: Jan. 31, 2008

(54) Methods and systems for the creation of consumer-customization and commercialization of goods

(75) Inventor: Michael Lee Brill, San Francisco, CA (US)

Correspondence Address: LEVINE BAGADE HAN LLP, 2483 EAST BAYSHORE ROAD, SUITE 100, PALO ALTO, CA, 94303, US

(73) Assignee: Crushpad, Inc., San Francisco, CA (US)

(21) Appl. No.: 11/496,956

(22) Filed: Jul. 31, 2006

(51) Int. Cl. G06Q 30/00

(52) U.S. Cl. 705/26

(57) ABSTRACT

Methods and systems are disclosed and described for the consumer-customization of products, and the commercialization thereof

### FIELD OF THE INVENTION

The present invention is related to the consumer-customization of manufactured goods and the commercialization thereof.

### BACKGROUND OF THE INVENTION

The advent of the Internet has immeasurably advanced and improved the manner and speed by which we proliferate and obtain information, communicate with each other, form relationships and transact business. Many products, services and activities, once unheard of or unavailable to us, are now only a few seconds and clicks away. All or part of the shopping/buying process, including product evaluation (e.g., determining pricing, availability), product customization (e.g., selecting size, style and color preferences) and/or purchasing of items and things such as clothing, tickets, groceries, furnishings, electronics, travel, stocks, automobiles, books, videos, antiques, music, trips and even housing, can be conducted online. In addition to providing consumers with unlimited access to products for purchase, the Internet has also enabled individual consumers to sell, market and distribute goods such as through online auctioning services (e.g., eBay®) and online classified sites (e.g., http://sfbay.craigslist.org).

The Internet also facilitates real-time telecommunication between individuals and within groups through tools such as email, instant messaging, chat rooms, forums, blogs, web casts, online gaming, etc. One can watch live events from around the world, listen to music, pay bills, auction goods, meet a future spouse, make reservations, track shipments, transfer funds and take advantage of a multitude of other services, all from the comfort of one's home or office and without direct verbal communication. In short, the resources and tools available through the Internet have made it possible to do things and obtain things that were not possible just a few decades ago.

The assignee of the present invention has set out to utilize these tools and resources in a novel manner to enable consumers to customize products according to their

individual preferences, and to enable them to commercialize those goods in the context of a consumer community desiring such customized goods.

### SUMMARY OF THE INVENTION

The present invention provides methods and systems for the consumer-customization and commercialization of goods. The subject methods include an overall business process for effecting the consumer-customization of goods as well as providing the ability and opportunity for a consumer to commercialize such goods to an identified or targeted consumer community interested in such goods.

One feature of the present invention is the opportunity, means and ability for consumers to customize their own products while utilizing the expertise, know-how and possibly even trade secrets, equipment, suppliers and human resources of an established manufacturer or producer of the types of products the consumer wishes to customize. More specifically, the consumer himself defines the specifications of the product which is in turn physically produced by a manufacturer or producer. An optional feature of the present invention is the opportunity for the consumer to participate in the actual fabrication, manufacturing and production process.

Where the goods are required to be made in bulk or volume (e.g., due to inefficiencies and costs in making only a single or limited number of units), the present invention provides and enables for the formation of consumer buying groups to collectively share in the cost and purchase of the customized goods. This feature is advantageous where the minimum amount of the desired product is too expensive or otherwise too voluminous for a single consumer to burden. In the context of wine-making, for example, a standard minimum volume of wine is one barrel, which equates to approximately 25 cases of wine, a very large volume which comes with a cost that a single consumer may not be willing to bear alone.

Another feature of the present invention is the opportunity, means and forum in which to commercialize, i.e., purchase and sell, the customized goods. Depending on the type of goods, the commercialization process may be conducted by the consumer-producer directly or facilitated by the direct manufacturer or producer of the goods while providing the consumer-seller with control over allocation of the products. As such, another process of the present invention provides for the pricing and allocation of units or portions of the available customer-produced product, either by the hosting producer to individual consumers or by a designated leader within a group of consumers. A variation of the invention allows for the reiteration of the pricing-allocation processes which includes the reallocation of available or unallocated units or goods with or without the re-pricing of those goods in response to the varying supply and demand for those goods. The allocation and/or pricing activities may be controlled by a hosting producer, a group leader or another designated individual or agent on behalf of the producer or a customer.

Yet another process of the present invention is the management of customer purchasing transactions and, optionally, the management of customer funds held in trust for the future purchase of the consumer-made products. The purchasing process may be configured to receive data (e.g., the number and price of units purchased by a customer) in accordance with the allocation activities mentioned above.

The system of the present invention enables, facilitates implements, manages and/or executes the subject business method or one or more processes or sub-processes thereof. To this end, variations of the system architecture include computers, servers, databases and/or other electronic-based telecommunications utilities and data storage means, and associated software algorithms and routines. In one embodiment, the system utilizes the Internet to establish real-time communication and data transmission links amongst the architectural structures of the system, where the system includes terminal points, such as personal computers, PDA's, cell phones, etc., for communication or data entry by and amongst consumers and the hosting producer.

These and other objects, advantages, and features of the invention will become apparent to those persons skilled in the art upon reading the details of the invention as more fully described below.

### BRIEF DESCRIPTION OF THE DRAWINGS

The invention is best understood from the following detailed description when read in conjunction with the accompanying drawings:

FIG. 1 is a schematic representation of a general overview of the possible participants and relationships involved in the context of a wine production application according to the present invention;

FIG. 2 is a block diagram of a system of the present invention for the consumer customization and production of wine implemented via the Internet;

FIGS. 3A and 3B provide a flow diagram of certain basic processes of a method of making, allocating and purchasing consumer-customized wine according to the present invention; and

FIG. 4 is a flow diagram of the pricing, allocation and reallocation processes of the method of the present invention.

### DETAILED DESCRIPTION OF THE INVENTION

The present invention provides a system and process for the consumer-customization of goods. The present invention may be particularly suitable in the context of products which tend to be highly subject to individual preference particularly where the product appeals to one's sense of taste, smell and/or style. Taste and fragrance tend to be highly subjective characteristics and can vary greatly from consumer to consumer Particularly for products at the higher end of the price spectrum and which appeal to consumers with sophisticated tastes, there is likely to be a higher customer demand for customization.

Ingestibles, such as foods, beverages, coffee, chocolate, chewing gum, candy, mints and certain vitamins and oral medications, as well as oral hygiene products such as toothpaste, mouthwash, breath fresheners, fluoride, dental floss, etc. are the types of goods for which the subject system and method may be suitable. The invention may also be suitable for fragrance-subjective goods such as cologne, perfume, air deoderizers, skin lotions, shampoo, soap, hair spray, laundry soap and other cleaning products, etc. Additionally, those products that tend to be subject to both taste and smell preferences, such as tobacco products, alcoholic beverages, lip balm, etc., may also be suitable for application of the present invention. Clothing is another category of goods which is very subject to individual consumer preferences.

In addition to product customization according to individual taste and smell preferences, the present invention is also suitable for use in the production of goods where consumers desire some control regarding the inclusion or exclusion of certain optional ingredients or compounds. Consumers are increasingly aware of their own health issues and the role that food and other ingestibles can impact certain conditions. For example, many health-conscious consumers limit or avoid foods and beverages that contain excess fat, sugars and cholesterol, or contain ingredients or allergens (e.g., wheat, nuts, dairy, etc.) known to negatively impact their health. Conversely, many consumers desire foods and beverages which contain healthful additives such as vitamins, minerals, fiber, etc. As evidence of this, the bottled water industry has met such demand by providing consumers with “artisan” waters having selected ingredients (e.g., vitamins, enzymes, salts, etc.) geared toward particular health or performance needs. In the context of wine, ingredients and production processes and techniques may be modulated, for example, to minimize the amount of sulfites or to control the sugar levels, acid levels, and/or the amount of tannins contained in the wine.

With these and other objectives in mind, the present invention is now described with reference to the drawings in the context of a system and method for the production and commercialization of consumer-customized wine. However, this embodiment of the invention should be taken to be illustrative of the invention and not limiting thereof as the present invention is well suited for use in the custom production of any product.

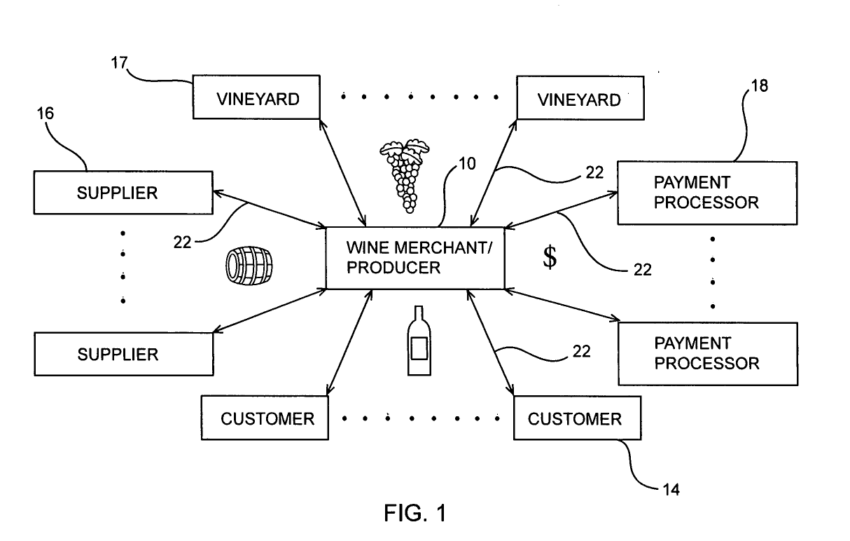

FIG. 1 provides an overview of the participants and relationships involved in the context of a wine production application according to the present invention. In this application, a wine merchant/producer 10 hosts the processes (executable software programs, ROM-based data, etc.) by which the subject methods are implemented. Alternatively, as discussed in greater detail below, the system host may be a provider of the computer hardware and software infrastructure which is capable of hosting and implementing the subject invention on behalf of a plurality of wine producers who simply provide the portal through which their customers are interconnected with the host system.

In the context of this disclosure, “wine merchant”, “wine producer” and “wine merchant-producer” are used interchangeably and mean the party which performs the physical tasks and services in the wine production and distribution process, in whole or in part, according to customer specifications and at customer direction. Such services may include sourcing grapes, obtaining wine production supplies and equipment (e.g., barrels, bottles, crushing equipment, etc.) from various vendors and suppliers 16, and using those supplies to crush grapes, ferment juice, barrel, age and bottle the wine. The wine producer may be a conventional winery having its own vineyards or source grapes from other vineyards, or may be another business entity which interfaces with a selection of wineries and/or vineyards 12 for sourcing grapes on behalf of customers 14. The assignee of the present invention, Crushpad, Inc. (crushpadwine.com), is one such business entity that is neither a conventional winery nor vineyard proprietor but provides all intervening services in the wine's transition from grapes to bottle to customer. Optionally, the wine producer 10 may also facilitate payment transactions between it and payment processors 18 (e.g., banks and credit card agencies) on behalf of customers for the payment of the wine produced through the wine producer.

In the context of this disclosure, the terms “customer” and “client” are used interchangeably herein to mean one or more consumers 14 which are registered or have an account with the wine merchant-producer 10 and interactively participate in the wine-production process hosted by the wine merchant-producer. The customer or client may be a single individual consumer, a group of individual consumers, a business entity (e.g., a wine retailer) or a group of business entities having an interest and the desire to play a role in producing a wine or wines according to his/her/their preferences. Where a business entity or a group of individuals is involved collectively as a “customer,” the group may have a leader or leaders (either self-appointed or elected by the other members of the group or business entity). The roles of the group leader (or the solo customer) are discussed below in greater detail.

In the context of the present invention, the communications and transactions between the wine producer 10 and its customers 14, vendors 12, 16 and other supporting businesses 18 (e.g., credit services) may be implemented and performed by any suitable mode of communication 20, including but not limited to telephonic, facsimile, email and mailed correspondences, etc. However, while many of the features and processes of the invention may be carried out in a variety of different ways, the invention is herein described in terms of a system and method adapted to utilize the Internet as a medium for communication amongst consumers 14 (where two or more consumers are involved in a group) and between the customer(s) and the wine producer 10, as well as between the wine producer and other supporting business 12, 16, 18.

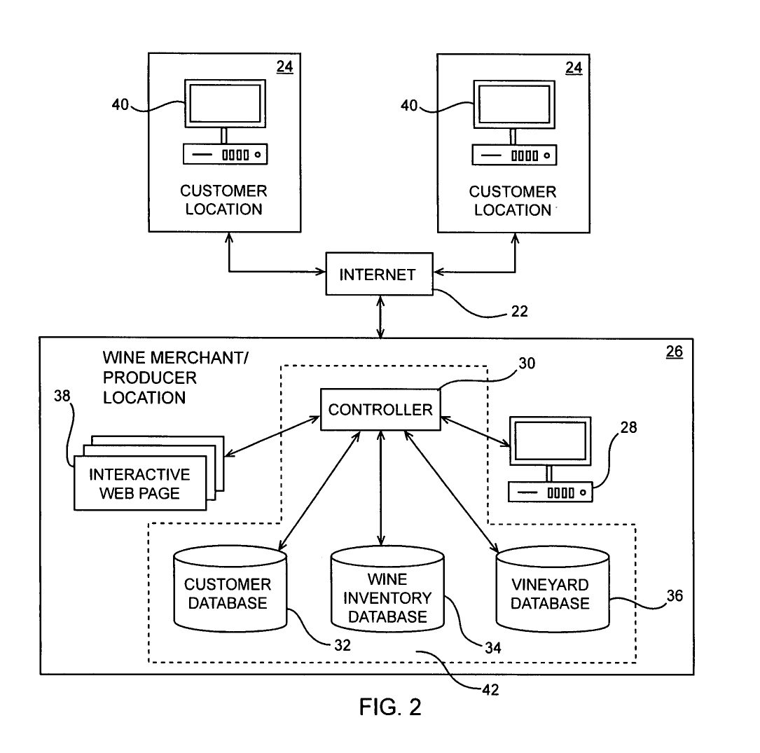

Referring now to FIG. 2, participating customers 24 may be located anywhere access can be made to the Internet 22 (or other electronic communication link) such as by means of a personal computer 40 (with monitor and keyboard), PDA or the like. While customer access and communication is anticipated to be primarily from remote locations, customers within the locale of the wine producer 10 may also choose to have face-to-face interaction with each other and with the wine producer. For example, a wine merchant-producer may offer customers the opportunity to periodically taste their wine in order to better gauge and modify the production technique if necessary to ensure the best possible outcome, i.e., a great tasting wine.

The wine merchant location 26 includes a computer 28 by which the wine merchant and its employees (e.g., the wine maker) establish, manage and maintain the host system server 42 and its processes (e.g., website), and communicate with customer locations 24 via the Internet 22. The server 42 includes a controller 30 which operates the system software, a plurality of databases 32, 34, 36 and communication buses (not identified) between the controller and the databases and between the controller and host computer 28. The system software includes executable code, databases for storage of data as well as source code and ROM data. Those skilled in the art will appreciate that controller 30 can be configured to perform any conceivable function required to implement the methods of the present invention; however, for brevity, certain of the general functions of the controller include but are not limited to managing communications amongst consumers and to and from the merchant-producer, managing transactions made by the merchant-producer or between customers, and storing and retrieving data to and from the databases.

Any type and number of databases may be employed for storing data including but not limited to a customer data base 32 which stores customer information (e.g., name, email, billing and shipping addresses, credit card or bank debit information), a wine inventory database 34 which stores information and data regarding the inventory of wine(s) available from all customers registered within the system and other supplies (e.g., barrel identification, customer ownership, barrel/bottle inventory, etc.) and a vineyard database 36 which stores information about the grape suppliers, available varietals, vineyard characteristics and harvesting information. While the merchant-producer may choose to have exclusive access to the wine inventory and vineyard databases 34, 36, it may want to allow customers to have access to their respective customer files, either directly to the customer database 32, or by establishing web account/pages which are password-accessible by respective customers. Customers may also choose to share their personal data with other customers either privately within the membership of a group or publicly with any registered customer of the system. Information which may be accessible by customers include but is not limited to the customer profiles, product specifications, wine status/calendaring information, etc., each of which is discussed in greater detail below.

The server 42 also hosts the merchant-producer's website which is accessible by customers via the Internet 22. Interactive web pages 38 are posted by the merchant-producer at its website and displayed at a customer location 24 using a customer's browser. The manner in which websites and web pages are accessed and displayed is commonly known by those skilled in the art. The web pages 38 facilitate, at least in part, the interface between the wine merchant and its customers.

The merchant-producer server 42 may also provide and support additional modes of interactivity including email, real-time chat rooms, forums, collaboratively-edited winemaking reference and customer blogs. The chat rooms, forums and blogs may be configured to be group-specific (i.e., limited to members of the same customer group) to discuss taste preferences, make allocations, etc.; varietal-specific (i.e., open to customers making the same type of varietal) to share information, ask questions and make recommendations related to producing that type of wine; or publicly accessible by all registered customers (could also include non-registered consumers) for the purpose of retailing wine sharing information on winemaking, tasting note; etc.

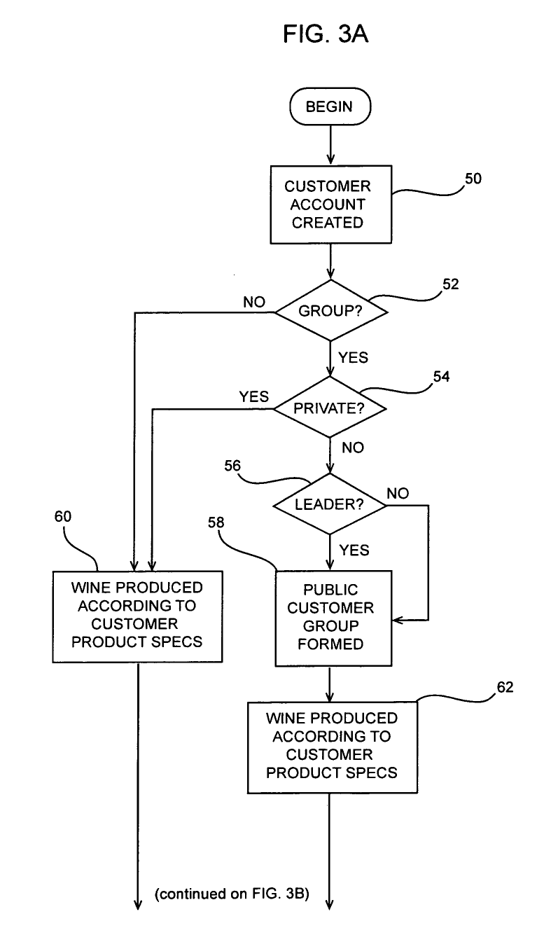

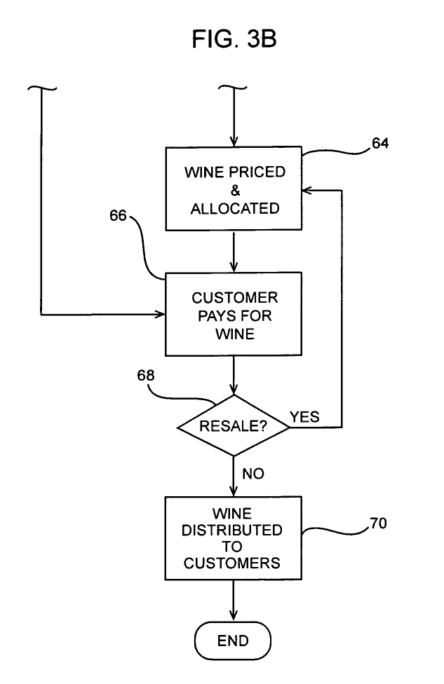

With reference to FIGS. 3A and 3B, a method of the present invention, which may be enabled by the subject system or portions thereof, or by other telecommunications and data transmission means known in the art, is described and illustrated. Once the merchant-producer's website is accessed by a consumer, if interested, the consumer may “register” as a customer, i.e., create an account with the merchant-producer (50). While minimal information, e.g., customer name and email address, may be required to establish an account with the merchant-producer, other information may be queried upon registration or at any other appropriate time during implementation of the subject method to establish a complete a customer profile. For example, it may be preferable to query a novice customer for wine preferences or specifications after affording him/her the opportunity to directly consult (by phone or in person) with the merchant-producer's wine maker and to ensure that the customer's desires and expectations are met. Additionally, to avoid obtaining information that may be subject to change by a customer's participation in a wine-making/buying group, certain queries may be more appropriately presented subsequent to the registration process, e.g., after the customer has been afforded the opportunity to join a group (52) or after a group has been formed (58) (described in greater detail below). On the other hand, certain information, such as wine varietal (e.g., Cabernet Sauvignon, Merlot, Chardonnay, Zinfandel, Pinot Noir, Syrah, Sangiovese, Riesling, Viogner, etc.), if queried initially, may facilitate placement of an individual in the appropriate group. In order to protect itself against loss, the wine merchant-producer may wish to request payment information, such as payment transaction information (e.g., credit card numbers, bank routing numbers, etc.), or obtain a cash advance to be placed in trust for a customer, at least prior to the first outlay of resources (e.g., the purchasing of grapes) it makes on behalf of a customer. This information is collected and used to form a customer profile which is stored as a data file in the customer database 32.

In addition to personal and financial information, wine-specific information is also obtained from or queried of the customer. This information may include but is not limited to the following: preferred grape source (e.g., Napa Valley, Sonoma Valley, Russian River, Central Coast, Oreg., etc.); preferred style (if any) of wine to be produced (e.g., a burgundian style Pinot Noir, un-oaked Chardonnay; etc.). Other information that may be queried of a customer (or otherwise determined by both the customer and the wine producer's wine maker outside the web page query/data entry process) are the wine's “finished” chemistry (e.g., alcohol level, brix level, varietal percentages if a multiple-varietal wine, etc.); crushing and de-stemming requirements (e.g., fully crushed or some whole cluster); pressing requirements (e.g., free run, light press, medium press, etc.); fermentation requirements (e.g., cold soak, natural yeast, yeast inoculation etc.); aging requirements (e.g., percentage of new oak, neutral oak, aging time, etc.) and finishing requirements (e.g., type and size of bottle, labels, capsules or wax cork/bottle coverings, etc.). Collectively, the wine-specific information forms all or part of the product specifications according to which the wine merchant is to produce the customer's wine. In addition to precisely defining the specifications of a wine to produced, much of the above information is useful to the wine merchant-producer in properly allocating its labor and production resources, ensuring sufficient supplies of grapes and production equipment, and estimating product pricing, i.e., the cost per bottle.

As mentioned above, a “customer” may be an individual or a group of individuals. As such, in one variation of the invention, a web page query may be crafted to determine whether a customer wishes to make wine alone (a “solo customer”) or as part of a group (52). If the customer wishes to participate as part of a group, he may be queried as to whether the group is a “private” group or a “public” group (54). For example, a winemaking group may be “private” whereby the group, such as a group of friends, may be formed independently and outside of the host system processes. A designated member (i.e., a “leader”) of the group may register the private group collectively under a group name or the member's own name. Members of the private group (other than the leader) may each individually choose to register as a customer but with limited access rights to the services of the host system. Access to and communication with registered members of a private group (e.g., through email or by a search conducted via the host system) may be limited to members of the same private group, to the group's leader and/or to the wine merchant-producer. For example, members of private groups who or not leaders may only be notified of general announcements pertaining to the customer base at large (e.g., the wine merchant's monthly newsletter) and/or only to the member's group (e.g., the group's crush date).

The “public” grouping process (58) may be configured in a variety of ways. In one variation, the wine merchant-producer itself groups individual customers (or groups of customers) into one or more groups, whereby the customers are matched at least according to the wine varietal they wish to produce. Other parameters which may be essential in optimizing group commonality are the style of wine preferred and the maximum acceptable price per bottle. The merchant-controlled grouping process may be performed manually or automatically by the host server 42 through the controller's 30 execution of a software program by which customer profiles stored in the customer database 32 are accessed, selected parameters therein are compared amongst the profiles, and customers with matching parameters are grouped into various public groups.

While all members of a public group may be granted access to the host system (i.e., for purposes of establishing an account with the wine merchant-producer, communicating with group members, participating in chat rooms, forums and blogs, accessing information about the status of their wine, transacting payments, allocating and reallocating wine allotments, etc.), in order to streamline the process and make it more efficient, the wine maker-producer may choose to limit all or some of the decision-making power and account privileges to the “group leader”, which may be a single individual or a subset of individuals of the group. As such, in one variation of the invention, upon electing to participate in a public group, the individual is queried as to whether he or she desires to be the group leader (56). The choice to be a leader or not may be queried during the registration process and included as part of the customer profile stored on the wine producer's customer database. In this way, in the context of the producer-controlled group-forming process described above, the wine producer can ensure that only one leader is assigned to each group. This information may also enable alternative processes by which public customer groups are formed.

Instead of the merchant-producer administering the formation of customer groups, the merchant-producer may allow and enable a group leader to control the formation of his/her own public group(s). In the latter case, the customer matching process is handled much like Internet-based group formation services (such as Yahoo® Groups) or dating services (such as Match.com®). The leader-controlled group formation processes (58) may be designed such that the leader identifies potential members from a pool or bank of customer profiles (accessed and compiled from the customer database) having taste and style preferences similar to hers, much in the same way the merchant-producer would identify customers for a participation in particular group. The group leader then “invites” selected customers to join her group, and the invited customers can choose to accept or decline the invitation. The offer and acceptance process may be facilitated via email through the host system server, much in the same way that a dating service controls email communication between individuals until they both decide to communicate outside the service's network. As with the merchant-controlled grouping process, each group leader forming her own group should consider factors such as the per-bottle cost/price of the wine that a customer is willing to pay. The process may be further configured such that a group leader may lead any number of wine-making groups.

Alternatively, the leader-controlled grouping process (58) may be configured such that a registered customer wishing to participate in a group, but not wanting to lead that group, initiates the group-forming process. In this variation, the customer is provided access to a pool or bank of profiles of group leaders, each looking for new members. The customer is likely to consider factors such as wine varietal and style, and the per-bottle price of the wine that the group intends to produce. The customer “solicits” one or more of the group leaders for admission into their respective groups. Each solicited group leader then decides if he wants the soliciting customer as part of his group. The process may be configured to allow a customer to join only one group or any number of groups, either led by the same or different group leaders.

The wine-making process (60, 62) (which in the context of this invention may include any number or all activities from harvesting to bottling) may extend over a period from about 6 months to about 24 months, depending on the varietal being produced. For example, at least about 9 months are required to produce red wines, and at least about 6 months are required to produce white wines. During this time, the wine producer may provide customers access to customer-specific files which include the status of their wines and the calendaring of various activities in the production process. For example, the customer may desire periodic discussions (either in-person, telephonic or by email) with the wine maker, which discussions can be scheduled in advanced and calendared. These discussions may cover things like racking, fining, aging, blending as well as recommendations by the wine maker as to whether any ingredients, such as acid, water, sugar or tannin, should be added to the wine. The status of the wine and its progress is updated as necessary, which status information is stored in the wine inventory database and accessible by customers through the customer profile or as a separately accessible file.

While the physical aspects (e.g., de-stemming, crushing, bottling, labeling, etc.) of the wine-making process (60, 62) of the subject method are performed by the merchant-producer and its professional wine makers, the process of defining a customer's product specifications is typically a joint effort by the customer and the winemaker. Initial product specifications are at least in part defined from the wine-specific data provided in a customer's profile. However, given the subjectivity of wine and the many variables that can affect the wine over the duration of the wine-making process, the initial product specifications are often modified by choices and decisions (made with or without the assistance of a wine maker) that are required of the customer along the way. Thus, the process of defining the product specifications is often a reiterative and dynamic process. The product specifications may be stored in the wine inventory database and accessible through the customer profile or as separately accessible files.

In addition to defining the particularities of the wine and the manner in which it is produced, the product specifications may also include bottle-related information such as the bottle format (or size, e.g., 750 mL, magnum, etc.), bottle shape (if made optional), corking material (e.g., cork, plastic), capping material (e.g., lead capsule, wax, twist-off cap) and the label design. For the latter, the merchant-producer may have artists and graphic designers as part of its staff to assist customers in this task. Communication between the artists/designers and the customers may be facilitated by the various communication features of the subject system and method discussed above, including the electronic presentation of graphical information.

While the public group forming process (58) has been illustrated and described as occurring prior to the winemaking process (62), public groups may also be formed after commencement of the winemaking process. Further, a group leader may choose to add additional members (and/or drop other members) at anytime after formation of the group. For example, if a surplus of wine remains after an initial allocation, the group leader may decide to add members to his group (rather than or in addition to reducing the price of the wine) to ensure all of the available wine is sold during the reallocation process (discussed in greater detail below). Delaying formation of a group until after production has commenced or even until production has been substantially completed may be an intentional party of a group leader's plan. The host system's processes also accommodate the situation where the formation of a public group, if not planned or contemplated, may be desirable for those wishing to offload a portion of the amount of wine they have already purchased or have committed to purchase. As such, public groups may be formed within the subject system and methods at the initiation and direction of other than a public group leader, i.e., by a solo customer, a registered member of a private group, a leader of a private group and a public group member. Notwithstanding how or when a group is formed, the wine producer is likely to require that at least a portion if not the entire cost of the wine to be produced be secured prior to production. This requirement is also likely to be placed on solo customers and private groups as well to ensure against loss on the part of the wine merchant-producer.

With the above in mind, there at least several public group forming scenarios which are accommodated by the subject system and method: (1) a group leader pays for all of the wine produced or to be produced, and subsequently allocates all or a portion of his wine inventory to group members whereby he is credited by the wine merchant-producer upon the merchant-producer securing payment from other group members; (2) a group leader first ascertains the total quantity of wine desired to be produced by the group, and then ensures that payments to the merchant-producer by the individual members are secured prior to confirming with the wine merchant-producer the quantity of wine to be produced; or (3) a group leader aggregates the demand for the defined wine and obtains payment information (e.g., credit card number) from each of the members on behalf of the producer prior to placing an order with the producer, who then administers allocation of the wine to the members and payment for the wine by the members.

Other aspects of the subject method include pricing the wine, allocating the wine to individual customers (64), and payment (66) and distribution (70) of the wine. Within a public group, the individual members may undertake and embark on the winemaking venture with a certain understanding and expectation of how much wine they are going to be allocated and how much it is going to cost them. As discussed above, the expected allocation and pricing are often established early on, either upon registration or soon thereafter, such as in the grouping process, where a public group leader defines the varietal to be produced and the price per bottle at which he intends to offer the wine. However, the actual costs incurred, sales price and available quantity of wine may vary somewhat in the end due to a variety of different factors. For example, the customer may decide to change the product specifications that impact the final cost of the wine. Independent of intentional changes to the product specifications, a better than expected wine quality may support an increase in the price of the wine, provided the group leader is not contractually bound to the originally quoted price. On the other hand, with a less than favorable outcome and without having contractually bound members to a fixed price, the group leader may have to lower the price to sell off his inventory. The addition or attrition of group members may also influence the pricing structure due to supply and demand. As such, for public customer groups, the final pricing and allocation of wine (64) may preferably be conducted upon completion of the wine-making process or at least after sufficient time during the aging process when the ultimate quality of the wine and the size of the customer base (i.e., group size) can be definitively determined.

With solo customers, pricing and allocation are often not issues as the customer is solely responsible for purchasing the entirety of the amount of wine produced at the price agreed upon with the wine merchant. This is also often the case with private groups where members (typically participating in wine making as a hobby and not for profit) agree amongst themselves to be collectively responsible for purchasing all of the wine produced at the price agreed upon with the wine merchant. As such, the initial pricing and allocation in these scenarios are often handled outside the context of the host system. However, as discussed below, each of the private group members and solo customers may choose to reallocate their initially allocated portion to others in a group or within the producer's customer base at large by use of the host system's resale process (68).

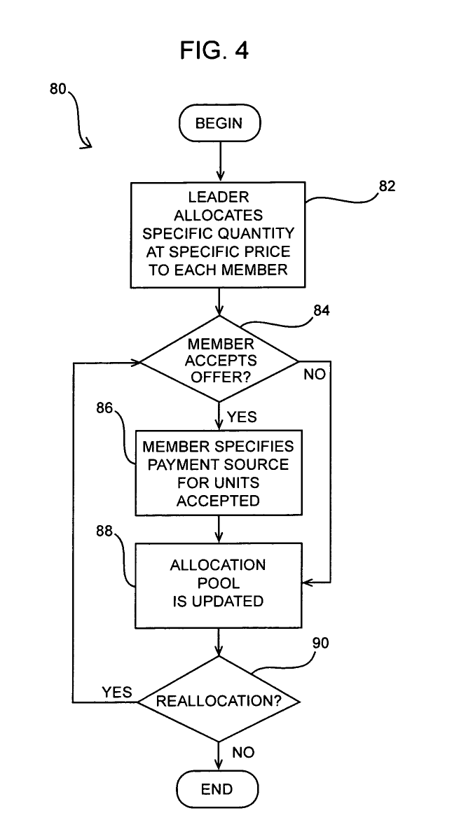

While the pricing and allocation (64) of wine within the context of the present invention may be discrete, one-time events, as indicated above, they are very often reiterative processes which may involve some interdependencies. The latter scenario (80), referred to as “reallocation,” is illustrated in more detail in FIG. 4.

The pricing and allocation of the wine (82) may be fixed or may vary from group member to group member. In other words, a group leader may allocate the same number of bottles/cases to each member at the same price per bottle/case, or may decide to allocate different amounts at the same price or the same amount to each member but at different prices, or both. For example, the group leader may offer staggered discounts based on volume (e.g., 10% discount for purchase of a case, 15% discount for purchase of two cases, etc.). Where the group leader does not have a prior binding agreement with a group member as to the quantity and price that a member is obligated to buy/pay and the leader is obligated to sell, the allocation and pricing “offer” (84) may be accepted or rejected by the member. Where a member declines the offer in whole, the quantity of wine previously allocated to him is “returned” to the allocation pool, which is updated accordingly (88). Where the member accepts all or a portion of the wine offered, the accepted number of units is secured by requiring the member to specify a payment source (86) (e.g., credit card, trust account, cash, etc.), and the allocation pool is updated accordingly (88) (i.e., unaccepted bottles/cases, if any, are returned to the allocation pool).

The group leader has the choice of extending offers to all group members simultaneously or extending offers successively. In the former case, the group leader should consider whether the sum of the individual units (bottles or cases) offered exceeds, is equal to or is less than the number of units within the allocation pool, which is dictated by the number of barrels made on behalf of the group. Typically, the initial allocation pool includes at least a minimum number of units of product required to be produced per customer. (Such a minimum number may be referred to as a “lot” or any other term commonly used in a particular product industry.) Just as an airline often oversells the number of seats to ensure a full flight and in anticipation of some cancellations, the group leader may want to ensure against any unsold units by offering more than the number units that are actually available within the allocation pool. On the other hand, if a group leader knows that demand will be high, he may wish to reserve a certain number of units from the initial allocation and offer them at a higher price on the open market (e.g., to a restaurant or wine retailer).

In the case where the group leader extends offers successively, the number of units allocated and/or the price thereof may be determined or varied based on the currently available inventory of wine within the allocation pool which will be dependent upon the acceptance and rejection of previous offers to other members. Where the group leader finds that a number of units of wine remain unallocated after the initial round of offers, he may wish to reallocate the remaining units (90) and make additional offers (84) to group members, either at the same or a different price. In this way, the pricing and allocation (i.e., reallocation) processes are reiterated, with the allocation pool continuously updated until all units of wine have been allocated and confirmed. At any point during the (reallocation) process, the group leader may choose to stop the process, and keep and pay for unallocated units himself.

The payment process (66) (see FIG. 3B) may also be reiterative where a group member purchases a certain quantity of wine and then later wishes to purchase more (if available) or return wine already purchased (if allowed by the group leader or the wine merchant). Reiteration may also occur in the situation where a group leader decides to change an initial allocation of wine already paid for by group members. These scenarios may “restart” or repeat the pricing, allocation (64) (reallocation) as well as the payment (66) processes.

While illustrated in FIG. 3B as generally occurring subsequent to the production of wine (62), as mentioned above, the present invention accommodates for payment of the wine (66) or the securing of such payment terms at any point after customer registration and prior to completion of the production process. For example, as mentioned above, payment (66) may be required (by either the producer or group leader) to be made prior to the commencement of the wine production process (62) in order to ensure against loss by the producer and/or to avoid the overproduction of wine, i.e., to avoid producing wine in quantities that cannot be completely allocated.

In one variation of the invention, payment and credit transactions are facilitated through third party payment processors 18 (e.g., bank, credit card issuer, credit union, etc.) (see FIG. 1). In another variation of the invention, a cash account is established by the merchant-producer for each customer (e.g., a group leader only or for every member of a group) with advance payment (by cash or check) where the money is accessible by and held in trust by the wine merchant—similar to the client trust accounts that attorneys are required to form when receiving advance payment from a client.

Use of cash accounts is particular suitable in the context of a public group where the leader pays for the entire anticipated quantity of goods to be produced prior to allocation of the goods to the group members. For example, a group leader desires to make a barrel of wine (equivalent to 25 cases) and pays the wine merchant-producer in advance for the 25 cases. A cash account is established by the producer on behalf of the leader. Typically, other members of the group will choose to pay by credit card at the allocation stage of the process. When the wine is then allocated to members by the leader, the merchant-producer receives payment from the credit card agencies and concurrently reimburses the leader's cash account for the number of cases allocated to other members. In groups where the leader does not wish to be solely responsible for advance payment of all of the wine to be produced, each of the group members may be required to establish cash accounts with the merchant producer. This arrangement gives the group leader the ability to unilaterally reduce the number of cases that a member has already been allotted and paid for. Upon such “reallocation” the member's cash account is credited for the reduction in the allocation and, in turn, the leader's and/or another member's cash account (depending on who receives the reallocated units) is then debited for the same amount. The system and method may be configured such that, at any time, the beneficiary of the cash account may request a withdrawal of some or all of the account's funds. The producer may then issue a credit in the form a check, credit card credit, wire transfer, etc. The cash account also enables members to pay in advance for future allocations.

Whether the customer account is established as a cash account with the producer or secured with a credit card through a third party payment processor, or by other means where financial transactions can be made electronically on behalf of the customer, the payment process (66) may include electronic transactions between the merchant-producer 10 and the customer 14 (solo customer, group leader or group member) or amongst customers (e.g., between the group leader and the group members) via secured routes on the Internet 22 or other electronic communications means. Such secured, electronic financial transactions are commonly known by those skilled in the art.

The payment process (66) can be configured such that transactions (either credits or deductions) can be automatically triggered upon the occurrence of an event or the meeting of a condition. For example, in the context of a public group, the payment transaction on behalf of a group member may be initiated by acceptance of an allocation by the member. For solo customers and group leaders (public or private), payments may be scheduled or requested periodically or prior to or after completion of an outlay of resources by the wine merchant (e.g., grape purchase, bottling, etc.). As such and as discussed above, illustration in FIG. 3B of the payment process (66) occurring subsequent to pricing and allocation of the wine (64) is only intended to be exemplary. In cases where wine inventory is reallocated subsequent to payment, a customer whose allocation has been decreased will be credited whereby the credits are effected immediately (such as when using a credit card) or kept in a trust account for future purchases or disbursement as determined by the customer.

The payee and payer in the context of the payment process (66) of the present invention depend on the relationships established between the wine producer and the group leader and/or between the group leader and members of her group. In a common scenario, the merchant-producer is the sole payee who is paid by the “customer” (e.g., the solo customer or group leaders) who produces the wine on his own behalf (i.e., whether he intends to keep the entire production or resell some or all of it). In other scenarios, there may be more than one payee and/or more than one payer. For example, most likely in the context of a public group whose formation is controlled or directed by the merchant-producer, the merchant-producer may establish an arrangement with the selected group leader to act as an agent on behalf of the merchant-producer whereby the merchant-producer pays the leader a commission or other compensation on the wine sales made to the members of his group. In the context of public groups formed by the self-appointed group leader, the leader may act as an agent on behalf of the members of his group and require a fee from each of the members for his services, i.e., for doing the “legwork” and/or acting as a consultant in the winemaking process.

The payment process (66) may further include the manner in which agent fees are transacted. Where the leader is a producer-agent, the producer may receive full payment from the “buyer” (i.e., each of the individual group members or a customer at large under the resale process (68)) and then subsequently pay the group leader the commission owed to him. Alternatively, the buyers may pay the leader directly who then distributes the proceeds to the producer less the commission owed to the group leader by the producer. Still yet, the buyers, particularly where the leader is a buyer-agent, may pay each of the leader (his commission) and the producer (its materials and production fee) directly. Finally, the all payment transactions may be performed by third party payment processor who distributes the proceeds and commissions to the producer and the leader, respectively.

As briefly mentioned above, the method of the invention may further include and accommodate the resale of purchased wine (68). In the context of the present invention, “resale” or “reselling” (used interchangeably) means the pricing and allocation (and reallocation) of wine (64, 80) where the wine being resold has been produced and, in some cases, already sold/purchased according to the subject method. As indicated in FIG. 3, this is another manner in which the pricing and allocation processes (64) of the present invention may be reiterated.

Any registered customer, either a solo customer or member of a private or public group (whether or not a leader), may “resell” wine. A “reseller” may choose to resell all or some of his wine for any number of reasons, e.g., a customer may not like the finished product; where a group leader is unable to allocate all the wine to members of his group and wants to recoup his losses; or where a customer desires to make a profit on the wine he has already purchased, etc. The resale process (68) may be configured such that the reseller may have access to and solicit population at large of registered customers or a selected population thereof. The sub-population of customers may be selected based on a variety of parameters in including but not limited to customers' advance agreement to receiving such solicitations, the varietal of the wine being resold (e.g., Pinot-producing customers may be interested in buying Pinot produced by others), etc. Any of these parameters may be queried and stored in the customer profile at various points during the various processes of the subject method, as discussed above. Within the context of the present invention, these sales forums provide the reseller the advantage of access to an identified or identifiable customer base desirous of purchasing such goods. Particularly for an individual contemplating a winemaking enterprise without having the necessary resources to purchase a vineyard or winery, production equipment and/or staff, the ability to sell his wares to a ready and available customer base (and one that is likely to have a more sophisticated palate then the average consumer) can provide invaluable feedback for further improving the wine and for establishing a future customer base.

In one embodiment of the invention, the hosting merchant-producer may also participate in the resale process (68) either as a buyer or a seller. In the latter role, the merchant-producer may wish to produce and sell its own wines, or may choose to resell product that was forfeited by a registered customer. In one variation of this embodiment, the merchant-producer may employ a customer or group leader as an agent acting on its behalf to facilitate the resale process who is then compensated by the merchant-producer, either by receiving a commission on the sale made or a discount on or an allotment of the wine sold. The subject system and method may also be adapted to allow and enable limited access to the resale process and participation therein by outside buyers (those who have not participated in the merchant-producer's system, but who nonetheless desire to buy available wine). These buyers may be wine wholesalers, retailers, distributors or collectors. The system may be further configured to operate the resale process (68) as an online auction, similar to the eBay® system.

A final step in the subject method is the distribution of the finished wine product to purchasing customer(s) (70). Product distribution (70) may occur subsequent to payment by the customer (as presented in FIG. 3B) or may occur concurrently, perhaps if and when a customer picks up the wine directly at the merchant-producer's facilities or upon delivery to the customer if so arranged.

It is noted that the subject system and method may be designed to operate within all domestic (state and federal) and international regulations regarding the production, sale, resale and distribution of wine.

Further, while the present invention has been described in the context of a system “hosted” by the wine merchant-producer, the subject system may be hosted by a third party who is exclusively a system provider and not in any way involved in the production of wine (other customized product). The such a third party host-provider may host the subject system/method on behalf of a plurality of wine merchant-producers as well as any other manufacturer or producer of ingestible goods or other customizable products desiring to offer product customization to its customers.

The subject method or portions or processes thereof described herein may be performed using the subject system or by other means. The methods may all comprise the act of providing or accessing a suitable system. Such provision may be performed by the merchant-producer at the host system or by the customer at the customer location. In other words, the act of “providing” merely requires the user obtain, access, approach, position, set-up, activate, power-up or otherwise act to provide the requisite structure or make the requisite decision or choice. Methods recited herein may be carried out in any order of the recited events which is logically possible, as well as in the recited order of events.

Exemplary aspects of the invention have been set forth above. As for other details of the present invention, these may be appreciated in connection with those generally known or appreciated by those with skill in the art. In addition, though the invention has been described in reference to several examples, optionally incorporating various features, the invention is not to be limited to that which is described or indicated as contemplated with respect to each variation of the invention. Various changes may be made to the invention described and equivalents (whether recited herein or not included for the sake of some brevity) may be substituted without departing from the true spirit and scope of the invention. In addition, where a range of values is provided, it is understood that every intervening value, between the upper and lower limit of that range and any other stated or intervening value in that stated range is encompassed within the invention.

Also, it is contemplated that any optional feature of the inventive variations described may be set forth and claimed independently, or in combination with any one or more of the features described herein. Reference to a singular item, includes the possibility that there are plural of the same items present. More specifically, as used herein and in the appended claims, the singular forms “a,” “an,” “said,” and “the” include plural referents unless the specifically stated otherwise. In other words, use of the articles allow for “at least one” of the subject item in the description above as well as the claims below. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

Without the use of such exclusive terminology, the term “comprising” in the claims shall allow for the inclusion of any additional element—irrespective of whether a given number of elements are enumerated in the claim, or the addition of a feature could be regarded as transforming the nature of an element set forth n the claims. Except as specifically defined herein, all technical and scientific terms used herein are to be given as broad a commonly understood meaning as possible while maintaining claim validity.

The breadth of the present invention is not to be limited to the examples provided and/or the subject specification, but rather only by the scope of the claim language. That being said, we claim:

I claim:

1. A method for the production of consumer-customized wine, the method comprising:
providing consumers remote access to participating in a wine production process comprising physical activities performed by a wine producer;
allowing one or more consumers to define the specifications of a wine to be produced; and
producing the wine according to the wine specifications and by the wine production process.

2. The method of claim 1 wherein the remote access is facilitated by the Internet.

3. The method of 1 further comprising allocating the wine to the one or more consumers.

4. The method of claim 3 wherein the wine is allocated prior to, during or after producing the wine.

5. The method of claim 1 further comprising pricing the wine.

6. The method of claim 5 wherein the wine is priced prior to allocating the wine.

7. The method of claim 3 further comprising reallocating the wine to one or more consumers.

8. The method of claim 7 further comprising repricing the wine.

9. The method of claim 1 further comprising obtaining consumer-specific information from the one or more consumers.

10. The method of claim 1 wherein the consumer-specific information comprises at least the wine varietal to be produced.

11. The method of claim 10 wherein the consumer-specific information further comprises a consumer's status as a solo customer or as a member of a customer group.

12. The method of claim 11 wherein, when the consumer is a member of a group, the consumer-specific information further comprises the status of the group as private or public.

13. The method of claim 11 wherein, when the consumer is a member of a group, the consumer-specific information further comprises a consumer's status as a leader or a non-leader.

14. The method of claim 1 wherein the one or more consumers are at a location having a computer and wherein the wine producer is at a location having a computer.

15. The method of claim 1 further comprising forming one or more groups of consumers wherein each group comprises at least two consumers and wherein each group produces a wine.

16. The method of claim 15 wherein the one or more groups are formed by the wine producer.

17. The method of claim 15 wherein the ore or more groups are formed by one or more consumers.

18. The method of claim 1 further comprising at least one consumer paying for the wine prior to producing the wine.

19. The method of claim 1 wherein the payment is made from a cash account held in trust by the wine producer on behalf of the at least one customer.

20. The method of claim 18 wherein the at least one consumer allocates one or more units of wine to another consumer.

21. A method for the production of a consumer-customized product, the method comprising:
establishing an Internet-accessible computer system whereby customers may access information provided by a merchant-producer and transmit information thereto;
querying customers for customer-specific information about the product to be produced;
receiving the customer-specific information transmitted by a customer in response to the querying;
establishing an electronic customer file containing the customer-specific information;
enabling the customer to define product specifications for the product to be produced; and
producing the product according to the customer specifications.

22. The method of claim 21 further comprising grouping customers based on similarities of selected customer-specific information.

23. The method of claim 22, wherein the grouping comprises running a software algorithm on the computer system whereby the electronic customer files are accessed and selected customer-specific information therein is compared between the customer files.

24. The method of claim 22 wherein the product is wine and the selected customer-specific information comprises the wine varietal to be produced.

25. The method of claim 24 wherein the selected customer-specific information further comprises the maximum price per bottle of wine to be produced.

26. The method of claim 22 wherein the grouping is performed by the merchant-producer.

27. The method of claim 22 wherein the grouping is performed by one or more customers.

28. The method of claim 21, wherein the customer is an individual.

29. The method of claim 21 wherein the customer is a leader of a group of individuals.

30. The method of claim 29 wherein the method further comprises forming the group.

31. The method of claim 30 wherein the group is formed prior to producing the wine.

32. The method of claim 31 wherein the group collectively defines the product specifications.

33. The method of claim 31 wherein the group is formed during or after producing the wine.

34. The method of claim 33 wherein the group leader defines the product specifications.

35. The method of claim 21 further comprising enabling the customer to commercialize the product to be produced.

36. The method of claim 35 wherein commercializing comprises allocating units of the product to one or more other customers for whom an electronic customer file has been established.

37. The method of claim 36 wherein the electronic customer files of the one or more customers to whom product units have been allocated comprise customer-specific information similar to the customer-specific information of the customer defining the product specifications.

38. The method of claim 35 wherein the customer pays for the product prior to commercializing the product.

39. A method of grouping customers according to product preferences for the purpose of producing a consumer-customized product, the method comprising:
querying interested customers for customer-specific information;
for each customer, compiling the customer-specific information into a customer file;
comparing selected customer-specific information amongst the respective customer files;
grouping customers based on similarities between the selected customer-specific information; and
producing a product according to specifications defined by a group wherein the specifications include at least one item of the selected customer-specific information.

40. The method of claim 39 wherein the querying comprises ascertaining whether an interested customer desires to be a leader of a group, and wherein the grouping comprises including one leader in each group formed.

41. The method of claim 40 wherein the grouping is performed by an entity who physically produces the product.

42. The method of claim 40 wherein the grouping is performed by one or more leaders.

43. The method of claim 42 wherein the one or more leaders invite other customers to join a group.

44. The method of claim 40 wherein a customer not desiring to be a leader requests one or more group leaders to join their respective groups.

45. The method of claim 39 wherein the grouping comprises comparing the customer files for similarity between at least one selected customer-specific information.

46. The method of claim 39 wherein the customer files are electronic files stored on a computer database and comparing the files comprises electronically accessing the database and running a software algorithm whereby customers are grouped according to similarity of the at least one selected customer-specific information.

47. The method of claim 39 wherein the product is wine and the at least one selected customer-specific information comprises the wine varietal to be produced.

48. The method of claim 39 wherein the querying comprises presenting web pages on a website accessible by the customers, wherein the web pages request customer-specific information to be entered electronically by the customers.

49. A method of allocating and reallocating product units within an allocation pool, the method comprising:
(a) determining the initial number of units in the allocation pool;
(b) offering a number of units in the allocation pool to one or more selected customers at a selected price per unit;
(c) securing payment from each customer accepting an offering;
(d) updating the number of units in the allocation pool based on the number of units accepted and declined by the selected customers; and
(e) repeating steps (b) through (d) if units remain within the allocation pool or as desired.

50. The method of claim 49 wherein the product units are cases of wine.

51. A system for the consumer-customization of manufactured goods wherein the system is electronically accessible by consumers and one or more manufacturers or producers of the goods, the system comprising;
one or more databases for storing information wherein the information comprises data about consumers using the system and the goods to be manufactured;
an electronic controller; and
software algorithms executable by the controller for enabling Internet-based communications between consumers and the one or more manufacturers, providing a website accessible by consumers via the Internet for the promotion of the one or more manufacturers' services and the querying of consumers for consumer-specific information regarding the goods to be manufactured, storing and retrieving information to and from the one or more databases, and enabling the one or more manufacturers to manage the production of the consumer-customized goods and to effect financial transactions.

52. The system of claim 51 wherein the system is hosted by a manufacturer of goods.

53. The system of claim 51 wherein the system is hosted by a third party and wherein a plurality of manufacturers use the system.

54. The system of claim 51 wherein the manufactured goods comprise ingestible products.

55. The system of claim 54 wherein the ingestible products comprise wine.
